(19) United States
(12) Patent Application Publication
(10) Pub. No.: US 2012/0162534 A1
(43) Pub. Date: Jun. 28, 2012

(54) RECEIVING CIRCUIT, SEMICONDUCTOR INTEGRATED CIRCUIT DEVICE, TELEVISION TUNER, AND TELEVISION RECEIVER

(76) Inventor: Kensuke BABA, Osaka (JP)

(21) Appl. No.: 13/304,057

(22) Filed: Nov. 23, 2011

(30) Foreign Application Priority Data
Dec. 24, 2010 (JP) 2010-287486

(51) Int. Cl. H04N 5/44; H04N 5/50

(52) U.S. Cl. 348/731; 348/725; 348/E05.096; 348/E05.097

(57) ABSTRACT

This receiving circuit includes a digital-control-type variable gain amplifier amplifying an RF signal for analog television broadcasting, a detection circuit detecting a level of an output signal of the amplifier and controlling gain of the amplifier such that the detected signal level attains a predetermined level, and a signal detection circuit setting a control signal (CNT) to the “H” level during a vertical blanking period in response to a vertical synchronizing signal. The detection circuit controls the gain of the amplifier during a time period in which the control signal (CNT) is set to the “H” level, and stops the control over the gain of the amplifier during the other time periods. Therefore, noise caused by gain fluctuations is created only during the vertical blanking period and does not appear on a television picture.

This nonprovisional application is based on Japanese Patent Application No. 2010-287486 filed on Dec. 24, 2010 with the Japan Patent Office, the entire contents of which are hereby incorporated by reference.

### BACKGROUND OF THE INVENTION

1. Field of the Invention

The present invention relates to a receiving circuit, a semiconductor integrated circuit device, a television tuner, and a television receiver. In particular, the present invention relates to a receiving circuit demodulating a high-frequency signal for television broadcasting received by an antenna and generating a video signal, a semiconductor integrated circuit device, a television tuner, and a television receiver.

2. Description of the Background Art

FIG. 7 is a circuit block diagram showing a configuration of a conventional tuner for receiving terrestrial television broadcasting. In FIG. 7, this tuner includes an input terminal 31, an input filter 32, a variable gain amplifier 33, an interstage filter 34, a mixer circuit 35, a local oscillation circuit 36, an IF (Intermediate Frequency) filter 37, a detection circuit 38, and a demodulation circuit 39.

Input terminal 31 receives an RF (Radio Frequency) signal transmitted from a terrestrial television broadcasting station and received by an antenna (not shown). Input filter 32 is an RF-BPF (Band-pass filter) and allows passage of a frequency component centered at a desired wave, reception of which is desired, among frequency components of the RF signal.

The RF signal that has passed through input filter 32 is amplified by variable gain amplifier 33. The gain of variable gain amplifier 33 is linearly controlled by an analog signal from detection circuit 38. Interstage filter 34 is an RF-BPF and allows passage of a frequency component centered at a desired wave, reception of which is desired, among frequency components of the RF signal amplified by variable gain amplifier 33. Interstage filter 34 removes a disturbing signal having a frequency closer to that of the desired wave than a disturbing signal removed by input filter 32.

Mixer circuit 35 converts the RF signal that has passed through interstage filter 34 into an IF signal having a certain intermediate frequency (for example, 57 MHz or the like), using a local oscillation signal from local oscillation circuit 36. Narrowband IF filter 37 is an IF-BPF and removes an adjacent signal from the IF signal. Demodulation circuit 39 demodulates the IF signal that has passed through IF filter 37 and generates a CVBS (Composite Video, Blank, and Sync) signal.

Detection circuit 38 detects a level of the IF signal that has passed through IF filter 37 and controls the gain of variable gain amplifier 33 such that the detected signal level attains a predetermined level. There has also been known a tuner in which a detection circuit in demodulation circuit 39 controls the gain of variable gain amplifier 33, instead of detection circuit 38.

“RF Variable-Gain Amplifiers and AGC Loops for Digital TV-IEICE TRANS. ELECTRON., VOL. E91-C, NO. 6 JUNE 2008” (Non-Patent Literature 1) also discloses a tuner including a digital-control-type variable gain amplifier. This literature 1 describes that when a conventional television tuner is formed as an IC (Integrated Circuit), linear degradation can be reduced by using the digital-control-type variable gain amplifier as an RF-VGA (Variable Gain Amplifier) unit. In addition, the digital-control-type variable gain amplifier in this literature 1 is very useful in a system like the television tuner in which a wide dynamic range from weak input to strong input is demanded.

When the above digital-control-type variable gain amplifier is used for receiving digital television broadcasting such as an ISDB-T (Integrated Services Digital Broadcasting-Terrestrial) and a DVB-T (Digital Video Broadcasting-Terrestrial) using an OFDM (Orthogonal Frequency Division Multiplexing) modulation scheme as well as an ATSC (Advanced Television Systems Committee) using an 8VSB (8-level Vestigial-Sideband) modulation scheme, effective results are obtained.

The gain of the above digital-control-type variable gain amplifier, however, changes in a stepwise manner. Therefore, when the above digital-control-type variable gain amplifier is used for receiving analog television broadcasting, the gain fluctuates sharply during reception and noise appears on a television picture.

### SUMMARY OF THE INVENTION

Thus, a main object of the present invention is to provide a receiving circuit that allows obtainment of a television picture having reduced noise, a semiconductor integrated circuit device, a television tuner, and a television receiver.

A receiving circuit according to the present invention includes: a variable gain amplifier of a digital control type amplifying a high-frequency signal for television broadcasting received by an antenna; a detection circuit detecting a level of an output signal of the variable gain amplifier and controlling gain of the variable gain amplifier such that the detected signal level attains a predetermined level; a frequency conversion circuit converting the output signal of the variable gain amplifier into an intermediate frequency signal; and a signal detection circuit detecting a synchronizing signal of a video signal from the intermediate frequency signal. The detection circuit controls the gain of the variable gain amplifier during a blanking period of the video signal in response to the synchronizing signal detected by the signal detection circuit, and stops the control over the gain of the variable gain amplifier during a time period other than the blanking period.

In addition, another receiving circuit according to the present invention includes: a variable gain amplifier of a digital control type amplifying a high-frequency signal for television broadcasting received by an antenna; a detection circuit detecting a level of an output signal of the variable gain amplifier and controlling gain of the variable gain amplifier such that the detected signal level attains a predetermined level; a demodulation circuit demodulating the output signal of the variable gain amplifier and generating a video signal; and a signal detection circuit detecting a synchronizing signal from the video signal. The detection circuit controls the gain of the variable gain amplifier during a blanking period of the video signal in response to the synchronizing signal detected by the signal detection circuit, and stops the control over the gain of the variable gain amplifier during a time period other than the blanking period.

Preferably, the synchronizing signal is a vertical synchronizing signal and the blanking period is a vertical blanking period.

In addition, preferably, the synchronizing signal is a horizontal synchronizing signal and the blanking period is a horizontal blanking period.

In addition, a semiconductor integrated circuit device according to the present invention includes the receiving circuit as described above.

In addition, a television tuner according to the present invention includes the receiving circuit as described above.

In addition, a television receiver according to the present invention includes the receiving circuit as described above.

In the receiving circuit according to the present invention, the detection circuit controls the gain of the variable gain amplifier during the blanking period of the video signal in response to the synchronizing signal detected by the signal detection circuit, and stops the control over the gain of the variable gain amplifier during a time period other than the blanking period. Therefore, noise caused by the gain control is not created during the time period other than the blanking period, and thus, a television picture having reduced noise can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit block diagram showing a configuration of a receiving circuit according to one embodiment of the present invention.

FIGS. 2A and 2B show waveforms of a CVBS signal and a vertical synchronizing signal shown in FIG. 1.

FIGS. 3A and 3B show waveforms of the CVBS signal and the vertical synchronizing signal shown in FIGS. 2A and 2B during a vertical blanking period.

FIG. 4 shows a waveform of the CVBS signal in a comparative example of the embodiment.

FIG. 5 is a circuit block diagram showing a modification of the embodiment.

FIG. 6 is a circuit block diagram showing another modification of the embodiment.

FIG. 7 is a circuit block diagram showing a configuration of a conventional receiving circuit.

### DESCRIPTION OF THE PREFERRED EMBODIMENTS

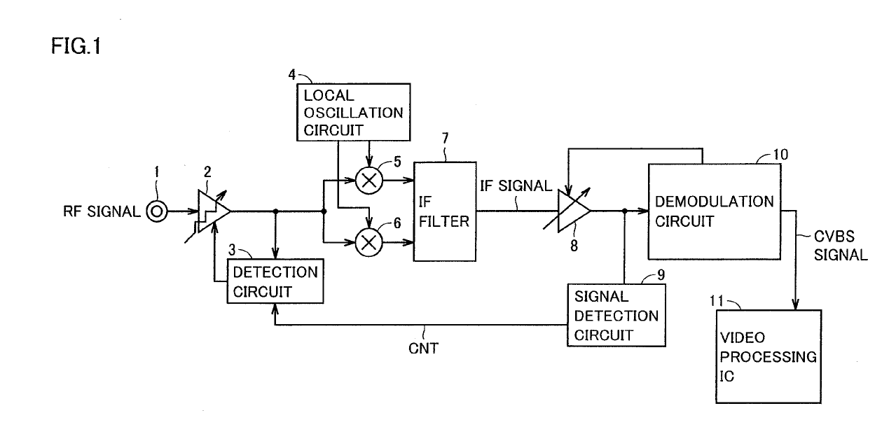

As shown in FIG. 1, a receiving circuit according to one embodiment of the present invention includes an input terminal 1, a digital-control-type variable gain amplifier 2, a detection circuit 3, a local oscillation circuit 4, mixer circuits 5 and 6, an IF filter 7, an analog-control-type variable gain amplifier 8, a signal detection circuit 9, a demodulation circuit 10, and a video processing IC 11.

Input terminal 1 receives an RF signal for analog television broadcasting received by an antenna (not shown). This RF signal is amplified by digital-control-type variable gain amplifier 2. The gain of digital-control-type variable gain amplifier 2 is changed in a stepwise manner by a digital control signal from detection circuit 3.

Local oscillation circuit 4 generates a real number axis local signal and an imaginary number axis local signal. Mixer circuits 5 and 6 make a frequency conversion of the RF signal amplified by digital-control-type variable gain amplifier 2 into an IF signal, using the real number axis local signal and the imaginary number axis local signal generated by local oscillation circuit 4.

The frequency of the IF signal outputted from mixer circuits 5 and 6 is restricted by IF filter 7 and the IF signal is amplified by analog-control-type variable gain amplifier 8. The gain of analog-control-type variable gain amplifier 8 is controlled by an analog control signal from demodulation circuit 10. Demodulation circuit 10 controls the gain of variable gain amplifier 8 by detecting a level of the IF signal amplified by variable gain amplifier 8 and generating the analog control signal such that the detected signal level attains a predetermined level. In addition, demodulation circuit 10 demodulates the IF signal and generates a CVBS signal. Video processing IC 11 performs various processing on the CVBS signal.

Signal detection circuit 9 detects a rising edge of a vertical synchronizing signal V_sync included in the IF signal amplified by analog-control-type variable gain amplifier 8, and sets a control signal CNT to the “H” level, which is an activated level, during a predetermined time period, in response to the detected rising edge of vertical synchronizing signal V_sync. As a result, control signal CNT is set to the activated level during a time period from the rising edge of vertical synchronizing signal V_sync to an end point of a vertical blanking period including this vertical synchronizing signal V_sync, and is set to the “L” level, which is an inactivated level, during the other time periods.

Detection circuit 3 detects a level of the RF signal amplified by digital-control-type variable gain amplifier 2 and generates a digital control signal such that the detected signal level attains a predetermined level. In other words, detection circuit 3 generates the digital control signal to increase the gain of variable gain amplifier 2 when the detected signal level is lower than the predetermined level, and generates the digital control signal to decrease the gain of variable gain amplifier 2 when the detected signal level is higher than the predetermined level.

In addition, detection circuit 3 changes the digital control signal only during the time period in which control signal CNT is set to the “H” level, which is the activated level, and fixes the digital control signal without any change during the time period in which control signal CNT is set to the “L” level, which is the inactivated level. As a result, the gain of digital-control-type variable gain amplifier 2 is changed as necessary during the vertical blanking period and is fixed without any change during the other time periods. Therefore, even if noise is created in the CVBS signal due to sharp fluctuations in the gain, the noise is never displayed on a television picture.

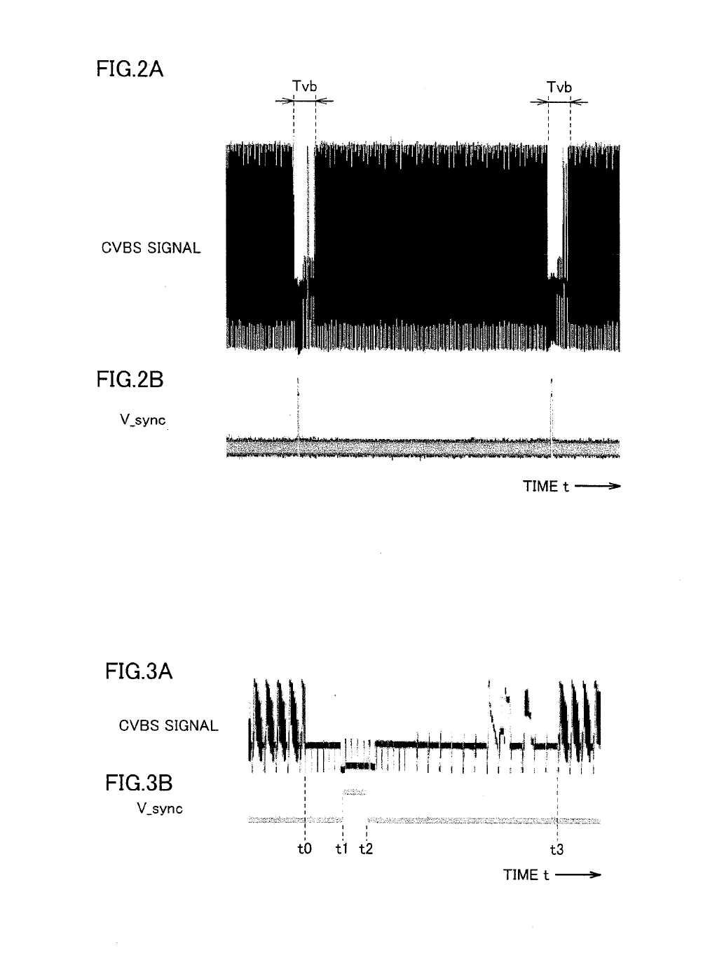

FIG. 2A is a waveform diagram showing the CVBS signal generated by the receiving circuit according to the present embodiment, and FIG. 2B is a waveform diagram showing vertical synchronizing signal V_sync included in the CVBS signal shown in FIG. 2A. In FIGS. 2A and 2B, the CVBS signal includes vertical synchronizing signal V_sync. Vertical synchronizing signal V_sync is a signal that is raised to the “H” level during a predetermined time period at a predetermined cycle. A vertical blanking period Tvb indicates a time period in which vertical synchronizing signal V_sync is set to the “H” level and certain time periods before and after the time period.

A signal between two vertical blanking periods Tvb is used to display a television picture for one screen. A signal in vertical blanking period Tvb is used to set a timing to start the television picture for one screen, and is not displayed on a screen. In the present embodiment, the gain of digital-control-type variable gain amplifier 2 is controlled only during vertical blanking period Tvb and the gain control stops during the other time periods. Therefore, as shown in FIGS. 2A and 2B, noise caused by gain fluctuations is created only during vertical blanking period Tvb and the noise caused by gain fluctuations is never displayed on the television picture.

FIGS. 3A and 3B are an enlarged view of a horizontal axis (time axis) in FIGS. 2A and 2B. In particular, FIG. 3A shows a waveform of the CVBS signal during vertical blanking period Tvb, and FIG. 3B shows a waveform of vertical synchronizing signal V_sync during vertical blanking period Tvb. In FIGS. 3A and 3B, times t0 to t3 correspond to vertical blanking period Tvb. Vertical synchronizing signal V_sync is set to the “H” level, which is the activated level, during times t1 to t2 between times t0 and t3, and is set to the “L” level, which is the inactivated level, during the other time periods. Control signal CNT is set to the “H” level, which is the activated level, during times t1 to t3, and the gain of digital-control-type variable gain amplifier 2 is controlled during times t1 to t3. Therefore, noise caused by fluctuations in the gain of digital-control-type variable gain amplifier 2 is created only during the time period from times t1 to t3.

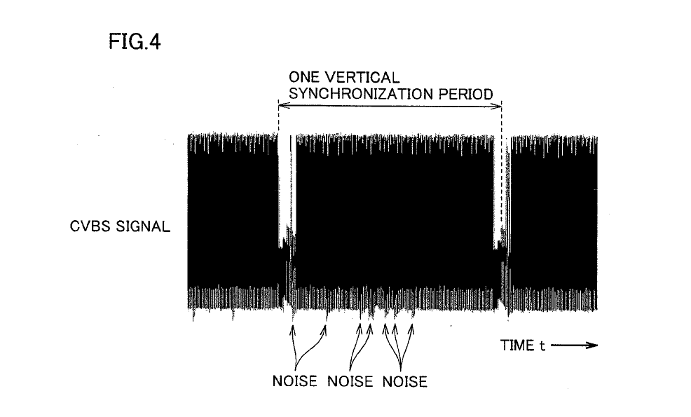

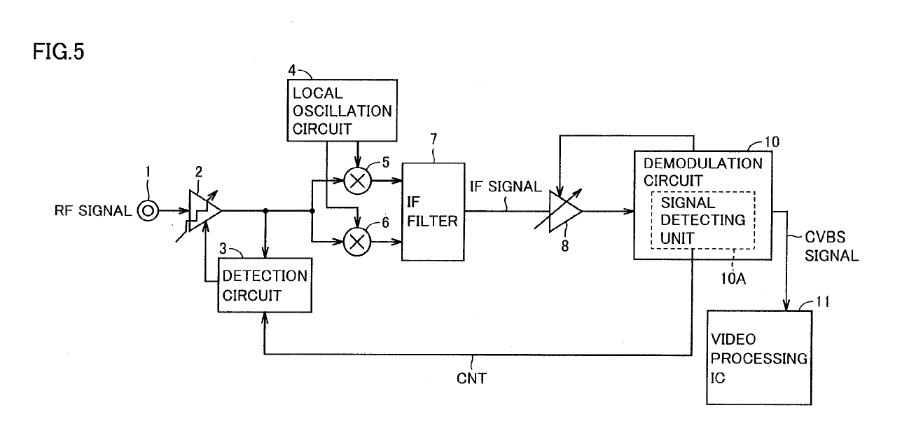

FIG. 4 shows a waveform of the CVBS signal generated by a receiving circuit according to a comparative example and is compared with FIG. 2A. This receiving circuit according to the comparative example is different from the receiving circuit in FIG. 1 in that signal detection circuit 9 is removed and detection circuit 3 constantly controls the gain of digital-control-type variable gain amplifier 2. Therefore, as shown in FIG. 4, noise caused by gain fluctuations is created in all time periods and the noise appears on a television picture.

FIG. 5 shows a modification of the embodiment and is compared with FIG. 1. In the present modification, signal detection circuit 9 is removed and a signal detecting unit 10A in demodulation circuit 10 generates control signal CNT. Signal detecting unit 10A detects the rising edge of vertical synchronizing signal V_sync included in the IF signal in demodulation circuit 10, and sets control signal CNT to the “H” level, which is the activated level, during a predetermined time period in response to the detected rising edge of vertical synchronizing signal V_sync. In the present modification as well, the same effect as that in the embodiment is obtained.

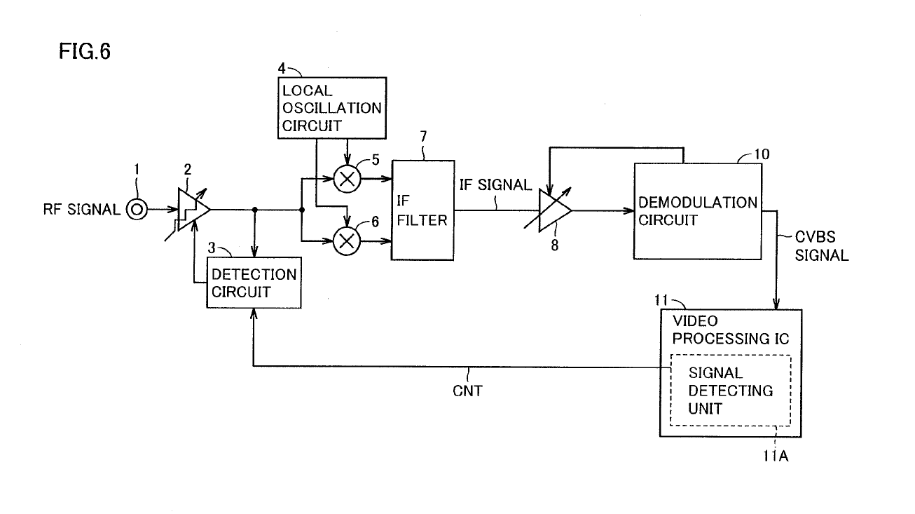

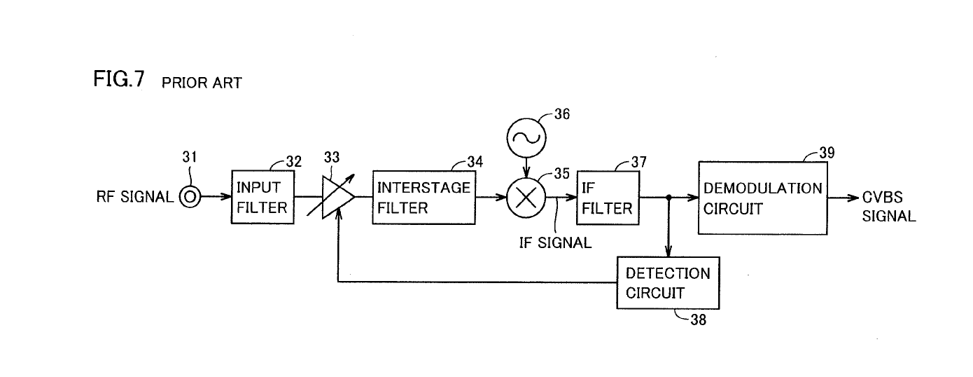

FIG. 6 shows another modification of the embodiment and is compared with FIG. 1. In the present modification, signal detection circuit 9 is removed and a signal detecting unit 11A in video processing IC 11 generates control signal CNT. Signal detecting unit 11A detects the rising edge of vertical synchronizing signal V_sync included in the CVBS signal in video processing IC 11, and sets control signal CNT to the “H” level, which is the activated level, during a predetermined time period in response to the detected rising edge of vertical synchronizing signal V_sync. In the present modification as well, the same effect as that in the embodiment is obtained.

Although the gain of digital-control-type variable gain amplifier 2 is controlled during vertical blanking period Tvb in response to vertical synchronizing signal V_sync in the present embodiment, the gain of digital-control-type variable gain amplifier 2 may be controlled during a horizontal blanking period in response to a horizontal synchronizing signal.

In other words, the CVBS signal includes the horizontal synchronizing signal. The horizontal synchronizing signal is a signal that is lowered to the “L” level during a predetermined time period at a predetermined cycle. The horizontal blanking period indicates a time period in which the horizontal synchronizing signal is set to the “L” level and certain time periods before and after the time period.

A signal between two horizontal blanking periods is used to display a television picture for one line. The television picture for one screen is formed of several hundreds of lines. A signal in the horizontal blanking period is used to set a timing to start the television picture for one line, and is not displayed on the screen. In the present modification, the gain of digital-control-type variable gain amplifier 2 is controlled only during the horizontal blanking period and the gain control stops during the other time periods. Therefore, noise caused by gain fluctuations is created only during the horizontal blanking period and the noise caused by gain fluctuations never appears on the television picture.

In this case, signal detection circuit 9 in FIG. 1, for example, detects a falling edge, which is a leading edge of the horizontal synchronizing signal included in the IF signal, and sets control signal CNT to the “H” level, which is the activated level, during a predetermined time period in response to the detected falling edge of the horizontal synchronizing signal. As a result, control signal CNT is set to the activated level only during a time period from the falling edge of the horizontal synchronizing signal to an end point of the horizontal blanking period including this horizontal synchronizing signal, and is set to the “L” level, which is the inactivated level, during the other time periods. In the present modification as well, the same effect as that in the embodiment is obtained.

It should be noted that a portion from input terminal 1 to demodulation circuit 10 (a portion other than video processing IC 11) in the receiving circuit shown in FIGS. 1, 5 and 6 is formed as one IC. In addition, the receiving circuit shown in FIGS. 1, 5 and 6 is mounted on a television tuner. In addition, the receiving circuit shown in FIGS. 1, 5 and 6 is mounted on a television receiver.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A receiving circuit, comprising:
a variable gain amplifier of a digital control type amplifying a high-frequency signal for television broadcasting received by an antenna;
a detection circuit detecting a level of an output signal of said variable gain amplifier and controlling gain of said variable gain amplifier such that the detected signal level attains a predetermined level;
a frequency conversion circuit converting the output signal of said variable gain amplifier into an intermediate frequency signal; and
a signal detection circuit detecting a synchronizing signal of a video signal from said intermediate frequency signal, wherein
said detection circuit controls the gain of said variable gain amplifier during a blanking period of said video signal in response to the synchronizing signal detected by said signal detection circuit, and stops the control over the gain of said variable gain amplifier during a time period other than said blanking period.

2. The receiving circuit according to claim 1, wherein
said synchronizing signal is a vertical synchronizing signal and said blanking period is a vertical blanking period.

3. The receiving circuit according to claim 1, wherein
said synchronizing signal is a horizontal synchronizing signal and said blanking period is a horizontal blanking period.

4. A semiconductor integrated circuit device, including the receiving circuit as recited in claim 1.

5. A television tuner, including the receiving circuit as recited in claim 1.

6. A television receiver, including the receiving circuit as recited in claim 1.

7. A receiving circuit, comprising:
a variable gain amplifier of a digital control type amplifying a high-frequency signal for television broadcasting received by an antenna;
a detection circuit detecting a level of an output signal of said variable gain amplifier and controlling gain of said variable gain amplifier such that the detected signal level attains a predetermined level;
a demodulation circuit demodulating the output signal of said variable gain amplifier and generating a video signal; and
a signal detection circuit detecting a synchronizing signal from said video signal, wherein
said detection circuit controls the gain of said variable gain amplifier during a blanking period of said video signal in response to the synchronizing signal detected by said signal detection circuit, and stops the control over the gain of said variable gain amplifier during a time period other than said blanking period.

8. The receiving circuit according to claim 7, wherein
said synchronizing signal is a vertical synchronizing signal and said blanking period is a vertical blanking period.

9. The receiving circuit according to claim 7, wherein
said synchronizing signal is a horizontal synchronizing signal and said blanking period is a horizontal blanking period.

10. A semiconductor integrated circuit device, including the receiving circuit as recited in claim 7.

11. A television tuner, including the receiving circuit as recited in claim 7.

12. A television receiver, including the receiving circuit as recited in claim 7.
